(19) United States
(12) Patent Application Publication
(10) Pub. No.: US 2025/0163527 A1
(43) Pub. Date: May 22, 2025

(54) METHOD AND SYSTEM TO PRODUCE A DIRECT REDUCED IRON PRODUCT WITH MULTIPLE CARBON LEVELS FROM A SINGLE SHAFT FURNACE

(71) Applicant: Midrex Technologies, Inc., Charlotte, NC (US)

(72) Inventors: Stephen Brooks, Creedmoor, NC (US); Stephen C. Montague, Midland, NC (US); Taiji Hatakeyama, Charlotte, NC (US)

(21) Appl. No.: 18/934,356

(22) Filed: Nov. 1, 2024

Related U.S. Application Data
(60) Provisional application No. 63/601,890, filed on Nov. 22, 2023.

(51) Int. Cl. C21B 13/14; C21B 13/02

(52) U.S. Cl. CPC C21B 13/14; C21B 13/02

(57) ABSTRACT

A method and system for producing a direct reduced iron product, including: generating hot direct reduced iron in a shaft furnace; receiving the hot direct reduced iron in a feed-leg downstream of the shaft furnace; and adding carbon to the hot direct reduced iron in the feed-leg downstream of the shaft furnace to form the direct reduced iron product. The process may further include receiving and briquetting the hot direct reduced iron with the carbon added to form the direct reduced iron product. The process may further include receiving the hot direct reduced iron in an additional (optionally parallel) feed-leg downstream of the shaft furnace and adding other carbon (in a different amount) to the hot direct reduced iron in the additional feed-leg downstream of the shaft furnace to form an additional direct reduced iron product having a different carbon content, using the same stream of hot direct reduced iron.

### CROSS-REFERENCE TO RELATED APPLICATION

The present disclosure claims the benefit of priority of U.S. Provisional Patent Application No. 63/601,890, filed on Nov. 22, 2023, and entitled “METHOD AND SYSTEM TO PRODUCE A DIRECT REDUCED IRON PRODUCT WITH MULTIPLE CARBON LEVELS FROM A SINGLE SHAFT FURNACE,” the contents of which are incorporated in full by reference.

### TECHNICAL FIELD

The present disclosure relates generally to the direct reduced iron (DRI) and steelmaking fields, especially in the area of process and product improvement. More specifically, the present disclosure relates to a method and system to produce hot DRI (HDRI), hot briquetted iron (HBI), or the like with multiple carbon levels from a continuously running single shaft furnace of a direct reduction (DR) plant.

### BACKGROUND

HDRI or HBI are the common feedstocks for an electric iron melter, such as an electric arc furnace (EAF), as the clean iron unit in a steelmaking process. In the case of melting high grade HDRI or HBI made from oxide having a high iron content (Fe>67 wt %), the HDRI or HBI can be fed to the melter to produce liquid steel, where the carbon content in the HDRI or HBI must be high enough to convert any remaining iron oxide (FeO) to iron (Fe) and provide the chemical energy in melting process.

In the case of melting low grade HDRI or HBI made from oxide having a lower iron content (Fe<65 wt %), to reduce the operating cost and improve the iron yield in melting the HDRI or HBI to produce liquid steel, two (2) step processes can be applied as practiced at blast furnace (BF) integrated steel mills. In the first melting step, the carbon content is typically C>3% in the hot metal as a target in melting the HDRI or HBI and removing the slag. In the second melting step, the carbon in the hot metal is decarburized with oxygen blowing to produce the liquid steel. Then, the higher amount of carbon must be added together with HDRI or HBI to achieve the target carbon content in the hot metal and at the first melting step.

In either of the above cases, the amount of carbon in some prior HDRI or HBI is not high enough to achieve these target values at the DRI melting process. Solid carbonaceous material and flux are usually added together with HDRI or HBI at the melting furnace, but the addition of the loose solid carbonaceous material yields a higher loss due to the entrainment in the slag or offgas discharged from the melter, which significantly increases the operating cost.

Additionally, the current state-of-the-art is to introduce elemental carbon into the DRI by using natural gas (NG) in and near the bottom of the shaft furnace and relying on thermochemical reactions to carburize the DRI pellets. Then, the amount carbon in the DRI added by the NG is limited due to the thermodynamic and chemical equilibrium restrictions. Further, DRI with only a single level of carbon content can be discharged from a given shaft furnace, while DRI with differing carbon levels may be desired at the downstream processes, such as the EAF or basic oxygen furnace (BOF) in the steel mills or the market users out of the steel mills. Accordingly, a new technology to simultaneously produce DRI streams with different levels of higher carbon from a single shaft furnace is demanded.

### BRIEF SUMMARY

Embodiments of the present invention address the foregoing needs and others.

Advantageously, embodiments of the present disclosure solve the foregoing problems as follows. Rather than relying on carburization chemistry in the shaft furnace to put carbon into the DRI product, embodiments of the present disclosure directly combine carbon into the product downstream of the feed-leg, which is downstream of the shaft furnace. This carbon product may be in different forms of graphitic carbon (including biocarbon) and may include a process to convert the graphitic carbon to cementite (Fe₃C). Since the shaft furnace supplies multiple feed-legs simultaneously, it is possible to have a different level of carbon for each feed-leg HDRI or HBI output.

Advantageously, embodiments of the present disclosure are generally applicable to any DR plant, but are especially beneficial to: (1) plants that require a high carbon product, (2) plants that have customers with different carbon content requirements for HDRI or HBI, (3) plants that must pay regulatory penalties for CO₂ emissions or strive to provide environmentally friendly products, and (4) hydrogen-only plants where zero carbon DRI is produced, which would require this type of secondary operation to add carbon to the product.

In some embodiments, the present disclosure provides a method for producing a direct reduced iron product, the method including: generating hot direct reduced iron in a shaft furnace; receiving the hot direct reduced iron in a feed-leg downstream of the shaft furnace; and adding carbon to the hot direct reduced iron in the feed-leg downstream of the shaft furnace to form the direct reduced iron product.

In some embodiments, the hot direct reduced iron is generated in the shaft furnace using hydrogen as a sole reductant.

In some embodiments, the method further includes creating fines in the hot direct reduced iron downstream of the shaft furnace and reheating the hot direct reduced iron in the feed-leg downstream of the shaft furnace.

In some embodiments, adding the carbon to the hot direct reduced iron in the feed-leg downstream of the shaft furnace includes metering and mixing the carbon into the hot direct reduced iron.

In some embodiments, the carbon added to the hot direct reduced iron in the feed-leg downstream of the shaft furnace is graphitic carbon. In some embodiments, the carbon added to the hot direct reduced iron in the feed-leg downstream of the shaft furnace is graphitic carbon converted to cementite. In some embodiments, the carbon added to the hot direct reduced iron in the feed-leg downstream of the shaft furnace is biocarbon.

In some embodiments, the method further includes receiving and briquetting the hot direct reduced iron with the carbon added to form the direct reduced iron product.

In some embodiments, the method further includes receiving the hot direct reduced iron in an additional (optionally parallel) feed-leg downstream of the shaft furnace and adding other carbon (in a different amount) to the hot direct reduced iron in the additional feed-leg downstream of the shaft furnace to form an additional direct reduced iron product having a different carbon content, using the same stream of hot direct reduced iron from the same shaft furnace.

In some embodiments, the present disclosure provides a system for producing a direct reduced iron product, the system including: a shaft furnace for generating hot direct reduced iron; a feed-leg for receiving the hot direct reduced iron downstream of the shaft furnace; and a carbon addition system for adding carbon to the hot direct reduced iron in the feed-leg downstream of the shaft furnace to form the direct reduced iron product.

In some embodiments, the hot direct reduced iron is generated in the shaft furnace using hydrogen as a sole reductant.

In some embodiments, the system further includes a hot direct reduced iron crusher for creating fines in the hot direct reduced iron downstream of the shaft furnace and a reheater system for reheating the hot direct reduced iron in the feed-leg downstream of the shaft furnace.

In some embodiments, adding the carbon to the hot direct reduced iron in the feed-leg downstream of the shaft furnace comprises metering and mixing the carbon into the hot direct reduced iron using a carbon metering and mixing system.

In some embodiments, the carbon added to the hot direct reduced iron in the feed-leg downstream of the shaft furnace is graphitic carbon. In some embodiments, the carbon added to the hot direct reduced iron in the feed-leg downstream of the shaft furnace is graphitic carbon converted to cementite. In some embodiments, the carbon added to the hot direct reduced iron in the feed-leg downstream of the shaft furnace is biocarbon.

In some embodiments, the system further includes a briquetting machine for receiving and briquetting the hot direct reduced iron with the carbon added to form the direct reduced iron product.

In some embodiments, the system further includes an additional (optionally parallel) feed-leg for receiving the hot direct reduced iron downstream of the shaft furnace and the carbon addition system or an additional carbon addition system for adding other carbon (in a different amount) to the hot direct reduced iron in the additional feed-leg downstream of the shaft furnace to form an additional direct reduced iron product having a different carbon content, using the same stream of hot direct reduced iron from the same shaft furnace.

It will be readily apparent to those of ordinary skill in the art that elements, limitations, aspects, and characteristics of the various embodiments of the present disclosure may be included, omitted, and combined as desired in a given application, without limitation.

### BRIEF DESCRIPTION OF THE DRAWINGS

The present disclosure is illustrated and described with reference to the various drawings, in which like reference numbers are used to denote like method steps/system components, as appropriate, and in which:

FIG. 1 is a schematic diagram illustrating an embodiment of the system of the present disclosure, depicting a shaft furnace and briquetting machine;

FIG. 2 is a schematic diagram illustrating an embodiment of the system of the present disclosure similar to FIG. 1, depicting a shaft furnace and briquetting machine, tailored to further reduce or eliminate CO₂ emissions in the DR production process;

FIG. 3 is a schematic diagram illustrating an embodiment of the system of the present disclosure similar to FIGS. 1 and 2, depicting a shaft furnace and briquetting machine, further showing a general representation of multiple feed-legs coupled to the shaft furnace, with each feed-leg capable of producing a specific and different carbon content HBI; and

FIG. 4 is a flowchart illustrating an embodiment of the method of the present disclosure.

It will be readily apparent to those of ordinary skill in the art that elements, limitations, aspects, and characteristics of the various drawings of the present disclosure may be included, omitted, and combined as desired in a given application, without limitation.

### DETAILED DESCRIPTION

Again, in various embodiments, the present disclosure relates generally to the DRI and steelmaking fields, especially in the area of process and product improvement. More specifically, the present disclosure relates to a method and system to produce DRI with multiple carbon levels from a single shaft furnace of a DR plant, providing the DR plant with the option to provide HDRI or HBI from an outlet of a continuously running shaft furnace.

Rather than relying on carburization chemistry in the shaft furnace to put carbon into the DRI product, embodiments of the present disclosure directly combine carbon into the product downstream of the feed-leg, which is downstream of the shaft furnace. This carbon product may be in different forms of graphitic carbon (including biocarbon) and may include a process to convert the graphitic carbon to cementite (Fe₃C). Since the shaft furnace may supply multiple feed-legs simultaneously, it is possible to have a different level of carbon from each feed-leg HBI output.

Advantageous benefits of embodiments of the present disclosure arise from the mixer: (1) working within the process line of existing DRI handling technology, (2) overcoming the tendency of graphitic carbon to segregate, and (3) creating a high carbon HBI product without compromising the briquette quality requirements such as strength and density.

An additional advantageous feature of embodiments of the present disclosure is the ability to output multiple carbon containing HBI products simultaneously (from different feed-legs) from a single shaft furnace. The location for the current embodiments of the present disclosure is within the feed-leg section, upstream of the briquetting machine, so the mixer is adapted to this location in each feed-leg section, both physically and from a process standpoint. The need to entrain the carbon uniformly, such that the resulting briquette maintains its strength, is a unique challenge addressed by the present disclosure.

Moreover, benefits of the designs include that the percentage of carbon in HBI is no longer limited by carburizing chemistry in the shaft furnace, allowing for products with up to 5% carbon or more. Furthermore, direct carbon incorporation at each feed-leg is more carbon efficient than the current state-of-the-art (carburizing), so any CO₂ emissions associated with producing the carbon containing HBI are minimized or eliminated. If the source of the carbon is organically derived, then CO₂ offsets or credits may be available.

Again, a primary benefit of the designs is that HBI products with multiple carbon percentages can be produced simultaneously using the same shaft furnace. The requirements of steelmakers for carbon in HBI may change from plant to plant, depending on other carbon inputs to the melting and steelmaking process. Under the current state-of-the-art, if a DR plant desires to deliver product to customers with different carbon requirements, the DR plant would have to fulfill one order with one carbon content requirement and then shift the process within the shaft furnace to produce the next order with a different carbon content requirement. This results in inefficiencies which embodiments of the present disclosure eliminate.

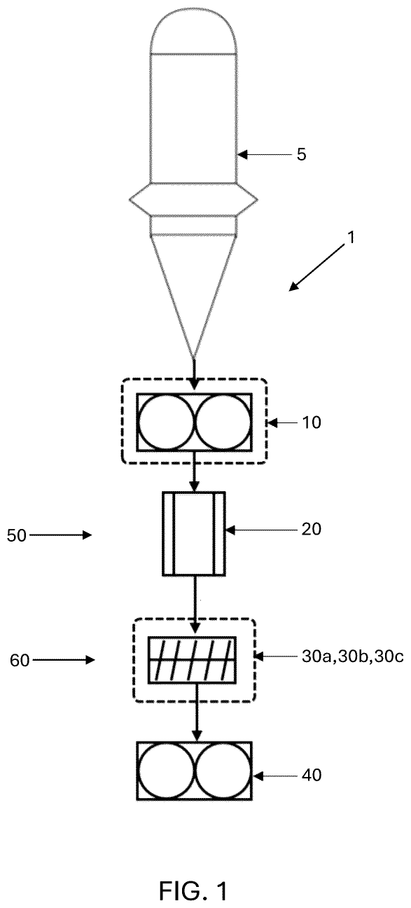

Referring now to the figures, FIGS. 1-3 schematically illustrate various arrangements of embodiments of the present disclosure. It is also noted that embodiments of the present disclosure share certain aspects with and address similar issues as US 2022/0403481, the contents of which are incorporated in full by reference.

FIG. 1 is a schematic diagram illustrating an embodiment of the system 1 of the present disclosure, depicting a shaft furnace 5 and briquetting machine 40. In particular, FIG. 1 shows a schematic representation of an embodiment of the present disclosure with the shaft furnace 5, briquetting machine 40, the conventional components between the entrance and exit of the feed-leg 50, and the process components of the carbon addition system 60 of the present disclosure downstream of the feed-leg 50.

The conventional components of each of the feed-legs 50 include an HDRI crusher 10 disposed downstream of the shaft furnace 5. This HDRI crusher 10 is adapted to create fines in the HDRI emanating from the shaft furnace 5 needed for proper compaction and strength and may be associated with a specific feed-leg 50 or common to all feed-legs 50. Each feed-leg 50, individually or collectively, may also include a reheat system 20 operable for reheating the HDRI emanating from the HDRI crusher 10 in each feed-leg conduit 55. Each feed-leg 50, individually or collectively, further includes a briquetting machine 40 disposed downstream of the feed-leg(s) 50 and the carbon addition system 60 of the present disclosure operable for briquetting the HDRI from the feed-leg(s) 50 to form HBI. The briquetting machine 40 may be omitted if the desired product is HDRI and not HBI for some or all feed-legs 50. In such cases, briquetting is not needed.

The process components of the carbon addition system(s) 60 of the feed-leg(s) 50 of the present disclosure are disposed between the feed leg(s) 50 and the briquetting machine(s) 40 and include: (1) an HDRI crusher 30a for creating additional fines in the HDRI needed for proper compaction and strength, (2) optionally an additional reheat system 30b to compensate for thermal losses associated with the DRI processing and transport, and (3) a specialized carbon addition, metering, and mixing system 30c for uniform carbon incorporation of a given feed-leg 50 into the DRI and the HBI before/during briquetting. FIG. 1 only depicts one feed-leg 50, but the process and equipment is replicated for each feed-leg 50, where a typical DR plant would have eight (8) feed-legs 50, for example. Thus, a tailored carbon content could be provided to the DRI of multiple different feed-legs 50 to provide multiple different carbon content HDRI or HBI outputs, all using the same shaft furnace 5 generating a single flow of DRI upstream of the feed-leg(s) 50.

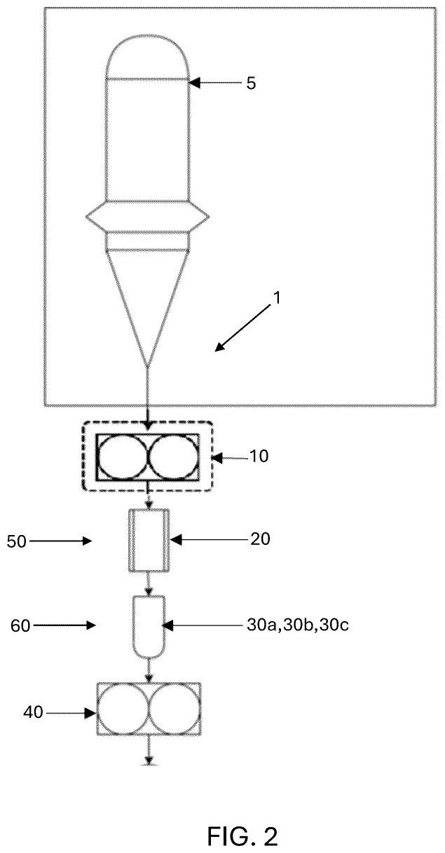

FIG. 2 is a schematic diagram illustrating an embodiment of the system 1 similar to FIG. 1 except that the system 1 is tailored to further reduce or eliminate CO₂ emissions in the DR production process. Here, the shaft furnace 5 uses hydrogen as the sole reductant, and the carbon material added to the DRI associated with each feed-leg 50 is specified as biocarbon. It is noted that FIG. 2 is intended to depict embodiments including a hydrogen only DR plant and/or the use of biocarbon for carbon addition as described.

In particular, FIG. 2 again shows a schematic representation of an embodiment of the present disclosure with the shaft furnace 5, briquetting machine 40, the conventional components between the entrance and exit of the feed-leg 50, and the process components of the carbon addition system 60 of the present disclosure downstream of the feed-leg 50.

The conventional components of each of the feed-legs 50 again include an HDRI crusher 10 disposed downstream of the shaft furnace 5. This HDRI crusher 10 is adapted to create fines in the HDRI emanating from the shaft furnace 5 needed for proper compaction and strength and may be associated with a specific feed-leg 50 or common to all feed-legs 50. Each feed-leg 50, individually or collectively, may also include a reheat system 20 operable for reheating the HDRI emanating from the HDRI crusher 10 in each feed-leg conduit 55. Each feed-leg 50, individually or collectively, further includes a briquetting machine 40 disposed downstream of the feed-leg(s) 50 and the carbon addition system 60 of the present disclosure operable for briquetting the HDRI from the feed-leg(s) 50 to form HBI. The briquetting machine 40 may be omitted if the desired product is HDRI and not HBI for some or all feed-legs 50. In such cases, briquetting is not needed.

The process components of the carbon addition system(s) 60 of the feed-leg(s) 50 of the present disclosure are again disposed between the feed leg(s) 50 and the briquetting machine(s) 40 and include: (1) an HDRI crusher 30a for creating additional fines in the HDRI needed for proper compaction and strength, (2) optionally an additional reheat system 30b to compensate for thermal losses associated with the DRI processing and transport, and (3) a specialized biocarbon addition, metering, and mixing system 30c for uniform carbon incorporation of a given feed-leg 50 into the DRI and the HBI before/during briquetting. FIG. 2 again only depicts one feed-leg 50, but the process and equipment is replicated for each feed-leg 50, where a typical DR plant would have eight (8) feed-legs 50, for example. Thus, a tailored carbon content could be provided to the DRI of multiple different feed-legs 50 to provide multiple different carbon content HDRI or HBI outputs, all using the same shaft furnace 5 generating a single flow of DRI upstream of the feed-leg(s) 50.

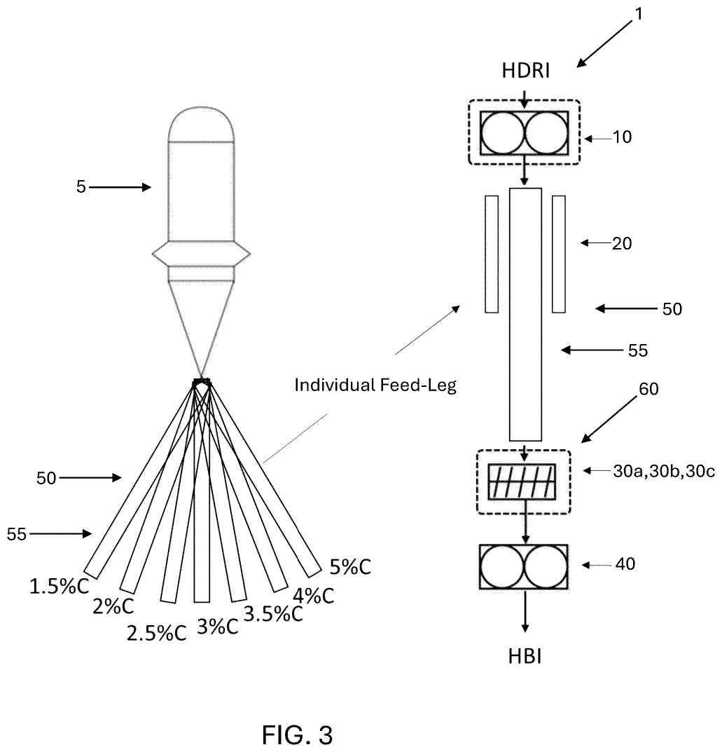

FIG. 3 is a schematic diagram illustrating an embodiment of the system 1 similar to FIGS. 1 and 2, and further showing a general representation of multiple feed-legs 50 existing the shaft furnace 5, with each feed-leg 50 capable of producing a specific and different carbon content HDRI or HBI product.

In particular, FIG. 3 again shows a schematic representation of an embodiment of the present disclosure with the shaft furnace 5, briquetting machine 40, the conventional components between the entrance and exit of the feed-leg 50, and the process components of the carbon addition system 60 of the present disclosure downstream of the feed-leg 50.

The conventional components of each of the feed-legs 50 again include an HDRI crusher 10 disposed downstream of the shaft furnace 5. This HDRI crusher 10 is adapted to create fines in the HDRI emanating from the shaft furnace 5 needed for proper compaction and strength and may be associated with a specific feed-leg 50 or common to all feed-legs 50. Each feed-leg 50, individually or collectively, may also include a reheat system 20 operable for reheating the HDRI emanating from the HDRI crusher 10 in each feed-leg conduit 55. Each feed-leg 50, individually or collectively, further includes a briquetting machine 40 disposed downstream of the feed-leg(s) 50 and the carbon addition system 60 of the present disclosure operable for briquetting the HDRI from the feed-leg(s) 50 to form HBI. The briquetting machine 40 may be omitted if the desired product is HDRI and not HBI for some or all feed-legs 50. In such cases, briquetting is not needed.

The process components of the carbon addition system(s) 60 of the feed-leg(s) 50 of the present disclosure are again disposed between the feed leg(s) 50 and the briquetting machine(s) 40 and include: (1) an HDRI crusher 30a for creating additional fines in the HDRI needed for proper compaction and strength, (2) optionally an additional reheat system 30b to compensate for thermal losses associated with the DRI processing and transport, and (3) a specialized carbon (or biocarbon) addition, metering, and mixing system 30c for uniform carbon incorporation of a given feed-leg 50 into the DRI and the HBI before/during briquetting. FIG. 3 again depicts one feed-leg 50, but the process and equipment is replicated for each feed-leg 50, where a typical DR plant would have eight (8) feed-legs 50, for example. Thus, a tailored carbon content could be provided to the DRI of multiple different feed-legs 50 to provide multiple different carbon content HDRI or HBI outputs, all using the same shaft furnace 5 generating a single flow of DRI upstream of the feed-leg(s) 50.

As illustrated, by way of example only, the HDRI or HBI emanating from different feed-legs 50 is 1.5% C, 2% C, 2.5% C, 3% C, 3.5% C, 4% C, and 5% C via the process components of the carbon addition system(s) 60 of the feed-leg(s) 50 of the present disclosure.

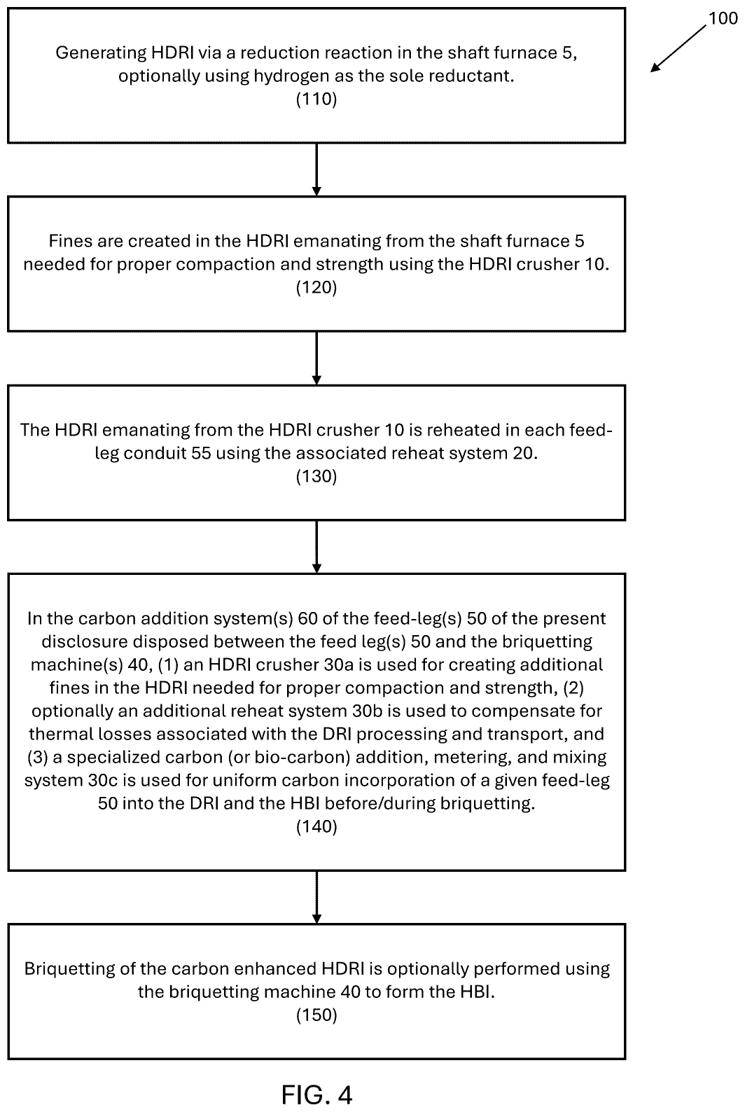

FIG. 4 is a flowchart illustrating an embodiment of the method 100 of the present disclosure. At step 110, the method 100 includes first generating HDRI via a reduction reaction in the shaft furnace 5, optionally using hydrogen as the sole reductant. At step 120, fines are created in the HDRI emanating from the shaft furnace 5 needed for proper compaction and strength using the HDRI crusher 10. At step 130, the HDRI emanating from the HDRI crusher 10 is reheated in each feed-leg conduit 55 using the associated reheat system 20. At step 140, in the carbon addition system(s) 60 of the feed-leg(s) 50 of the present disclosure disposed between the feed leg(s) 50 and the briquetting machine(s) 40, (1) an HDRI crusher 30a is used for creating additional fines in the HDRI needed for proper compaction and strength, (2) optionally an additional reheat system 30b is used to compensate for thermal losses associated with the DRI processing and transport, and (3) a specialized carbon (or biocarbon) addition, metering, and mixing system 30c is used for uniform carbon incorporation of a given feed-leg 50 into the DRI and the HBI before/during briquetting. The process and equipment is replicated for each feed-leg 50, where a typical DR plant would have eight (8) feed-legs 50, for example. Thus, a tailored carbon content could be provided to the DRI of multiple different feed-legs 50 to provide multiple different carbon content HDRI or HBI outputs, all using the same shaft furnace 5 generating a single flow of DRI upstream of the feed-leg(s) 50. At step 150, briquetting of the carbon enhanced HDRI is optionally performed using the briquetting machine 40 to form the HBI. Again, the briquetting machine 40 may be omitted if the desired product is HDRI and not HBI for some or all feed-legs 50. In such cases, briquetting is not needed.

Although the present disclosure is illustrated and described with reference to preferred embodiments and specific examples, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes. Additionally, all elements, limitations, and features described and claimed may be used in any combination in various embodiments.

What is claimed is:

1. A method for producing a direct reduced iron product, the method comprising:
generating hot direct reduced iron in a shaft furnace;
receiving the hot direct reduced iron in a feed-leg downstream of the shaft furnace;
adding carbon to the hot direct reduced iron in the feed-leg downstream of the shaft furnace to form the direct reduced iron product;
receiving the hot direct reduced iron in an additional feed-leg downstream of the shaft furnace; and
adding other carbon to the hot direct reduced iron in the additional feed-leg downstream of the shaft furnace to form an additional direct reduced iron product, wherein the carbon content of the additional direct reduced iron product is different from the direct reduced iron product.

2. The method of claim 1, wherein the hot direct reduced iron is generated in the shaft furnace using hydrogen as a sole reductant.

3. The method of claim 1, further comprising creating fines in the hot direct reduced iron downstream of the shaft furnace.

4. The method of claim 1, further comprising reheating the hot direct reduced iron in the feed-leg downstream of the shaft furnace.

5. The method of claim 1, wherein adding the carbon to the hot direct reduced iron in the feed-leg downstream of the shaft furnace comprises metering and mixing the carbon into the hot direct reduced iron.

6. The method of claim 1, wherein the carbon added to the hot direct reduced iron in the feed-leg downstream of the shaft furnace is graphitic carbon.

7. The method of claim 1, wherein the carbon added to the hot direct reduced iron in the feed-leg downstream of the shaft furnace is graphitic carbon converted to cementite.

8. The method of claim 1, wherein the carbon added to the hot direct reduced iron in the feed-leg downstream of the shaft furnace is biocarbon.

9. The method of claim 1, further comprising receiving and briquetting the hot direct reduced iron with the carbon added to form the direct reduced iron product.

10. The method of claim 1, wherein the additional feed-leg downstream of the shaft furnace operates in parallel to the feed-leg downstream of the shaft furnace to form another additional direct reduced iron product.

11. A system for producing a direct reduced iron product, the system comprising:
a shaft furnace for generating hot direct reduced iron;
a feed-leg for receiving the hot direct reduced iron downstream of the shaft furnace;
a carbon addition system for adding carbon to the hot direct reduced iron in the feed-leg downstream of the shaft furnace to form the direct reduced iron product;
an additional feed-leg for receiving the hot direct reduced iron downstream of the shaft furnace; and
the carbon addition system or an additional carbon addition system for adding other carbon to the hot direct reduced iron in the additional feed-leg downstream of the shaft furnace to form an additional direct reduced iron product, wherein the carbon content of the additional direct reduced iron product is different from the direct reduced iron product.

12. The system of claim 11, wherein the hot direct reduced iron is generated in the shaft furnace using hydrogen as a sole reductant.

13. The system of claim 11, further comprising a hot direct reduced iron crusher for creating fines in the hot direct reduced iron downstream of the shaft furnace.

14. The system of claim 11, further comprising a reheater system for reheating the hot direct reduced iron in the feed-leg downstream of the shaft furnace.

15. The system of claim 11, wherein adding the carbon to the hot direct reduced iron in the feed-leg downstream of the shaft furnace comprises metering and mixing the carbon into the hot direct reduced iron using a carbon metering and mixing system.

16. The system of claim 11, wherein the carbon added to the hot direct reduced iron in the feed-leg downstream of the shaft furnace is graphitic carbon.

17. The system of claim 11, wherein the carbon added to the hot direct reduced iron in the feed-leg downstream of the shaft furnace is graphitic carbon converted to cementite.

18. The system of claim 11, wherein the carbon added to the hot direct reduced iron in the feed-leg downstream of the shaft furnace is biocarbon.

19. The system of claim 11, further comprising a briquetting machine for receiving and briquetting the hot direct reduced iron with the carbon added to form the direct reduced iron product.

20. The system of claim 11, wherein the additional feed-leg downstream of the shaft furnace operates in parallel to the feed-leg downstream of the shaft furnace to form another additional direct reduced iron product.
